(19) United States
(12) Patent Application Publication
(10) Pub. No.: US 2010/0039992 A1
(43) Pub. Date: Feb. 18, 2010

(54) ACQUISITION OF ACCESS POINT INFORMATION WITH ASSISTANCE FROM OTHER ACCESS POINTS

(75) Inventors: Rajat Prakash, La Jolla, CA (US); Rajarshi Gupta, Santa Clara, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/539,717

(22) Filed: Aug. 12, 2009

Related U.S. Application Data
(60) Provisional application No. 61/089,845, filed on Aug. 18, 2008.

(51) Int. Cl. H04W 88/08

(52) U.S. Cl. 370/328

(57) ABSTRACT

An access point acquires information about another access point from at least one other access point. For example, the access point may send a query to one or more neighbor access points to obtain information about the other access point. In some aspects these operations may be employed in conjunction with establishing neighbor relations in a network. For example, in the event a neighbor list of a given access point does not have certain information about another access point (e.g., an IP address), the given access point may query its neighbor access points to see whether those access points have information about the other access point in their neighbor lists. Upon receipt of this information, the given access point may use the information to establish neighbor relations with the other access point.

### CLAIM OF PRIORITY

This application claims the benefit of and priority to commonly owned U.S. Provisional Patent Application No. 61/089,845, filed Aug. 18, 2008, and assigned Attorney Docket No. 082452P1, the disclosure of which is hereby incorporated by reference herein.

### BACKGROUND

1. Field

This application relates generally to communication and more specifically, but not exclusively, to acquiring access point information with assistance from one or more other access points.

2. Introduction

Wireless communication networks may be deployed over a geographical area to provide various types of services (e.g., voice, data, multimedia services, etc.) to users within that geographical area. In a typical implementation, access points are distributed throughout a network to provide wireless connectivity for access terminals (e.g., cell phones) that are operating within the geographical area served by the network. In general, at a given point in time, the access terminal will be served by a given one of these access points. As an access terminal roams throughout this geographical area (e.g., moves closer to another access point), the access terminal will be handed-over from its serving access point to the other access point.

To facilitate these handovers and other operations, access points in a network may maintain information about their neighbor access points (e.g., potential target access points). For example, context information may need to be sent from a serving access point to a neighbor access point when initiating a handover to that neighbor access point. To enable this context transfer, the serving access point may need to maintain information that indicates how communication with the neighbor access point is established.

In certain wireless communication systems, such those employing ultra mobile broadband (UMB) technology or long term evolution (LTE) technology having an evolved packet system (EPS), the communication network linking the access points may be used by the access points to communicate respective information to other access points in the network. Here, the access points may comprise, for example, evolved base stations (eBSs) in a converged access network, such as a radio area network (RAN), connected via an access gateway (AGW). In such systems, an access terminal may report identifying information (e.g., a pilot identifier) it hears from a nearby access point to its serving access point. Depending on the circumstances, this report may cause the network to determine that the access terminal should be handed-over to the nearby access point. In general, if the nearby access point is known to the serving access point, the identifying information may provide sufficient information to enable the serving access point to handover the access terminal to the nearby access point. However, whenever a new access point is added or removed from a conventional RAN, an operator may manually reconfigure all of the nearby access points with information about the access point. In practice, this reconfiguration operation may be particularly burdensome, may make acquisition expensive, and may make the network less homogeneous, particularly if temporary access points are used within the network.

### SUMMARY

A summary of sample aspects of the disclosure follows. It should be understood that any reference to the term aspects herein may refer to one or more aspects of the disclosure.

The disclosure relates in some aspects to acquiring information about an access point from at least one other access point. For example, an access point may receive a report from a served access terminal that identifies another access point (e.g., a target access point). If the identified access point is not known by the serving access point, the serving access point may send a query to one or more other access points to obtain information about the identified access point.

In some aspects the teachings herein may be employed in conjunction with establishing neighbor relations in a network. For example, each access point in the network may maintain a neighbor list that includes information about its neighbor access points. Accordingly, in the event the neighbor list of a serving access point does not have information about a target access point, the serving access point may query its neighbor access points (e.g., as identified in the neighbor list) to see whether those access points have information about the target access point in their neighbor lists. Upon receipt of this information from one of the neighbor access points, the serving access point may use this information to update a neighbor relations database (e.g., the serving and target access points may exchange information to update their respective neighbor lists).

As a specific example of the above, access points in a network may be assigned different types of identifiers. For example, the access points may be assigned first identifiers (e.g., IP or network layer identifiers) that may be used to uniquely identify and/or access the access points. In addition, the access points may be assigned less unique second identifiers (e.g., physical layer identifiers) that may be used to more efficiently identify the access points. In some cases, when an access terminal sends a handover request to its serving access point, the access terminal may only report the second identifier of a target access point to the serving access point. In these cases, upon receiving the handover request, if the serving access point does not know the first identifier of the target access point, the serving access point may query its neighbor access points, asking them for the first identifier (e.g., IP address) that corresponds to the received second identifier (e.g., physical layer identifier). If any of these neighbor access points knows the first identifier, it will send a response including the first identifier. Since the second identifier may be expected to be unique within a neighborhood of access points, it may be expected that a unique response will be returned by one or more of the neighbor access points. In the event the second identifier is not unique within this neighborhood, however, the serving access point may take steps to select one of the identified access points or resolve the conflict. Once the serving access point acquires the first identifier, the serving access point may use the first identifier to conduct neighbor relations with the target access point.

### BRIEF DESCRIPTION OF THE DRAWINGS

These and other sample aspects of the disclosure will be described in the detailed description and the appended claims that follow, and in the accompanying drawings, wherein:

FIG. 1 is a simplified block diagram of several sample aspects of a communication system wherein an access point may acquire information about another access point with assistance from one or more other access points;

FIG. 2 is a simplified diagram of sample message flow in a system wherein an access point acquires information about another access point;

FIGS. 3A and 3B are a flowchart of several sample aspects of operations that may be performed in conjunction with an access point acquiring information about another access point;

FIG. 4 is a simplified block diagram of several sample aspects of components that may be employed in communication nodes;

FIG. 5 is a flowchart of several sample aspects of operations that may be performed in conjunction with selecting an identifier from conflicting identifiers provided in responses from different nodes;

FIG. 6 is a flowchart of several sample aspects of operations that may be performed in conjunction with sending queries in a serial manner;

FIG. 7 is a flowchart of several sample aspects of operations that may be performed in conjunction with forwarding queries; and

FIGS. 8 and 9 are simplified block diagrams of several sample aspects of apparatuses configured to provide functionality relating to information acquisition as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

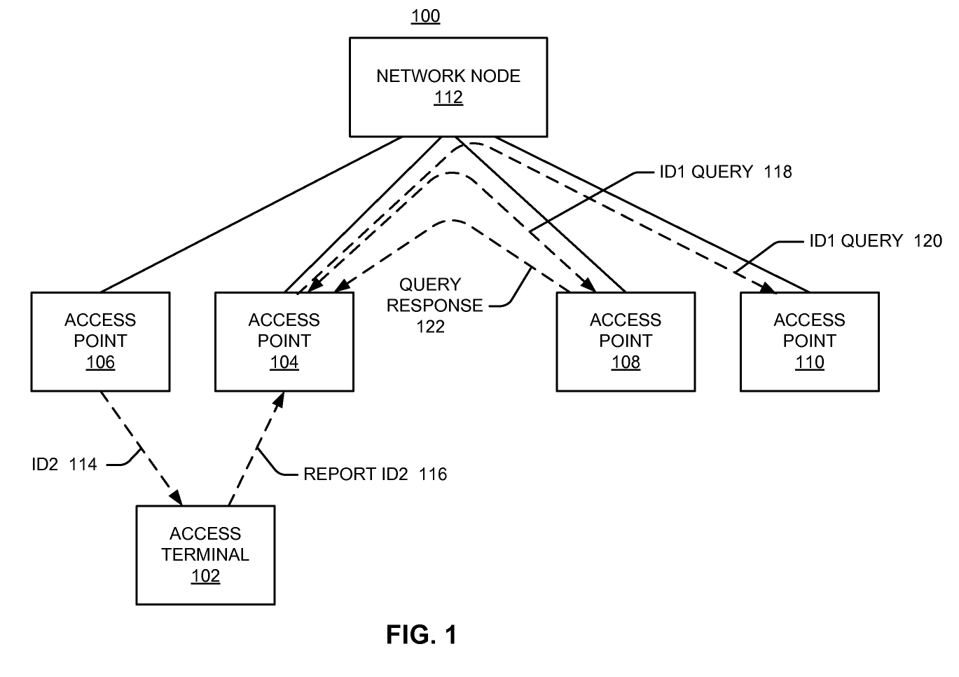

FIG. 1 illustrates several nodes of a sample communication system 100 (e.g., a portion of a communication network). For illustration purposes, various aspects of the disclosure will be described in the context of one or more access terminals, access points, and network nodes that communicate with one another. It should be appreciated, however, that the teachings herein may be applicable to other types of apparatuses or other similar apparatuses that are referenced using other terminology. For example, in various implementations access points may be referred to or implemented as base stations, eNodeBs, and so on, and access terminals may be referred to or implemented as user equipment, mobile communication devices, and so on.

Access points in the system 100 provide one or more services (e.g., network connectivity) for one or more wireless terminals (e.g., access terminal 102) that may be deployed within or that may roam throughout the coverage area of the system 100. For example, at various points in time the access terminal 102 may connect to an access point 104, an access point 106, or any one of a plurality of other access points (represented by access points 108 and 110 and the associated ellipsis). Each of the access points 104-110 may communicate with one or more network nodes (represented, for convenience, by network node 112) to facilitate wide area network connectivity. Such network nodes may take various forms such as, for example, one or more radio and/or core network entities. Thus, in various implementations the network node 112 may comprise a configuration manager, a mobility management entity, or some other suitable network entity.

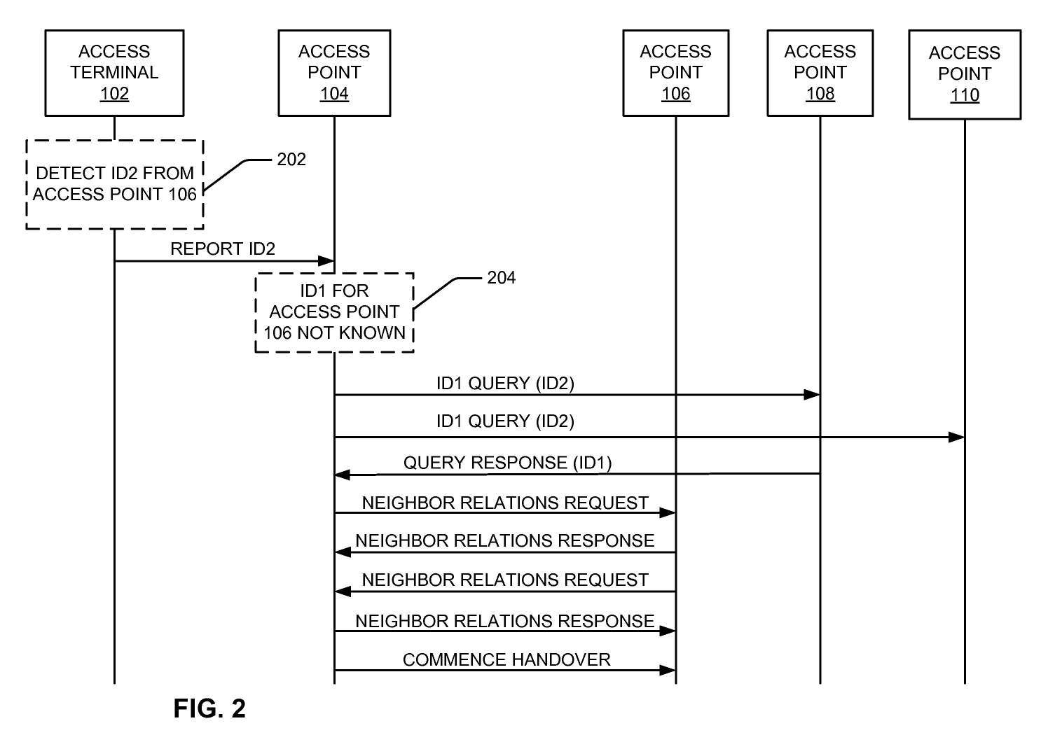

In accordance with the teachings herein, an access point in the system 100 may obtain information about another access point from one or more other access points. For illustration purposes, FIGS. 1 and 2 depict sample message flow for a case where the access point 104 sends queries to the access points 108 and 110 to obtain information about the access point 106. Here, the vertical direction of the message flow represents time or sequential ordering of the messages between the various devices.

In a typical implementation, the access points 106, 108, and 110 are so-called neighbor access points of the access point 104. Here, a first-hop (or direct) neighbor of a particular access point may be defined as an access point to which an access terminal that may be served by the particular access point may be handed-over. For example, a first-hop neighbor may be defined as an access point that is geographically situated relative to a particular access point such that the neighbor represents a viable candidate to which to an access terminal currently served by the particular access point might handed off to (e.g., when the access terminal changes its location). In other words, the first-hop neighbor is close enough to the particular access point such that an access terminal currently being served by that access point may be handed-over to the first-hop neighbor. Other types of neighbor relationships may be employed in various implementations. For example, a particular access point may obtain information about another access point from a two-hop neighbor.

To facilitate communication with the access points, different types of identifiers may be assigned to each of the access points. The following describes a scenario where each access point is assigned a first identifier (e.g., a unique identifier such as an IP address) and a second identifier (e.g., a smaller sized but a less unique identifier such as a physical cell identifier). It should be appreciated, however, that the teachings herein are applicable to scenarios where more than two identifiers are assigned to an access point.

The message flow of FIGS. 1 and 2 relates to a scenario where the access terminal 102 is initially being served by the access point 104 and is then handed-over to the access point 106 after the access terminal 102 reports the second identifier of the access point 106 to the access point 104. It should be appreciated, however, that the information acquisition techniques described herein may be applicable to other scenarios (e.g., where an access point discovers the second identifier of the access point 106 in some other way).

As represented by block 202 of FIG. 2, at some point in time the access terminal 102 detects a second identifier (ID2) transmitted by the access point 106. For example, the access terminal 102 may have moved within the coverage area of the access point 106 or the access point 106 may have just been activated. In this case, the access terminal 102 may receive a pilot signal or some other type of signal broadcast by the access point 106. The transmission of the second identifier from the access point 106 to the access terminal 102 is represented by a dashed line 114 in FIG. 1.

At some later point in time the access terminal 102 reports the second identifier to the access point 104. For example, the access terminal 102 may send a measurement report or other similar message whenever the access terminal 102 detects a new pilot signal exceeding a threshold level. In some cases the access terminal 102 may send these reports periodically. The transmission of the report including the second identifier from the access terminal 102 to the access point 104 is represented by a dashed line 116 in FIG. 1.

As represented by block 204 of FIG. 2, receipt of the second identifier may constitute a trigger that causes the access point 104 to determine whether it knows the first identifier corresponding to the second identifier. For example, as discussed above, since the second identifier may not uniquely identify the access point 106 in the system, the access point 104 may need to use the first identifier to establish communication with the access point 106.

In the event the first identifier corresponding to the received second identifier is not known by the access point 104, the access point 104 may send queries (ID1 QUERY) for the first identifier to its neighbor access points, where the queries include the second identifier (ID2). The example of FIG. 2 illustrates one query message being sent to access point 108 and another query message being sent to access point 110. The transmissions of these query messages are represented by dashed lines 118 and 120 in FIG. 1. It should be appreciated that a different number of query messages may be sent in different scenarios.

The examples of FIGS. 1 and 2 illustrate a scenario where the first identifier is known by the access point 108. Hence, the access point 108 sends a response message (QUERY RESPONSE) that includes the first identifier (ID1) to the access point 104. The transmission of this response message is represented by dashed line 122 in FIG. 1.

Once the access point 104 acquires the first identifier for the access point 106, the access point 104 may use this information to update its neighbor relations database (e.g., neighbor list). For example, the access point 104 may communicate with the access point 106 or some other entity (e.g., a centralized network entity) to acquire information about the access point 106. In a typical case, the access point 104 uses the information to establish neighbor relations with the access point 106. For example, the access point 104 may use the first identifier (e.g., an IP address) to send a neighbor relations request to the access point 106. This request will include information (e.g., the first identifier of the access point 104) to enable the access point 106 to send a response to the request. In a complementary manner, the access point 106 may send a neighbor relations request to the access point 104, to which the access point 104 sends a corresponding response. At this point neighbor relations may be established between the access points 104 and 106. Accordingly, each of the access points may acquire identifying information of the other access point such as the IP address of the access point, supported access gateway addresses, geographical location, zone information, paging-related information, topological and routing information, and protocol interface version. In addition, the access points may exchange information from their respective neighbor lists.

Thus, in the event conditions in the system 100 warrant the access terminal 102 being handed-over to the access point 106, the access point 104 will have sufficient information about the access point 106 to commence handover operations. This action is represented in FIG. 2 by the commence handover message at the bottom of the figure.

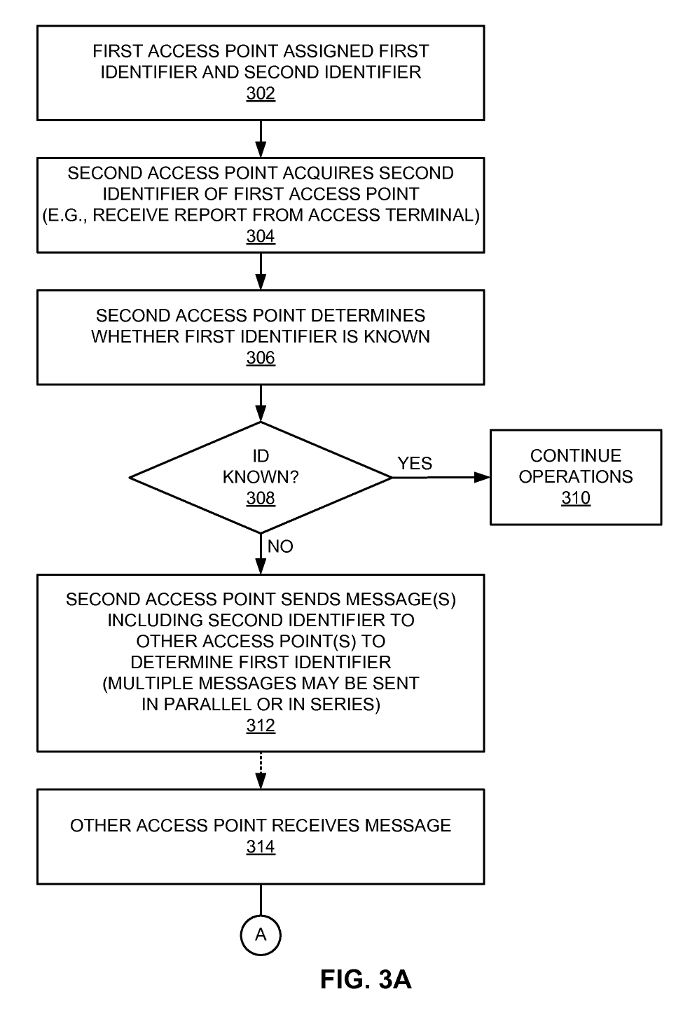

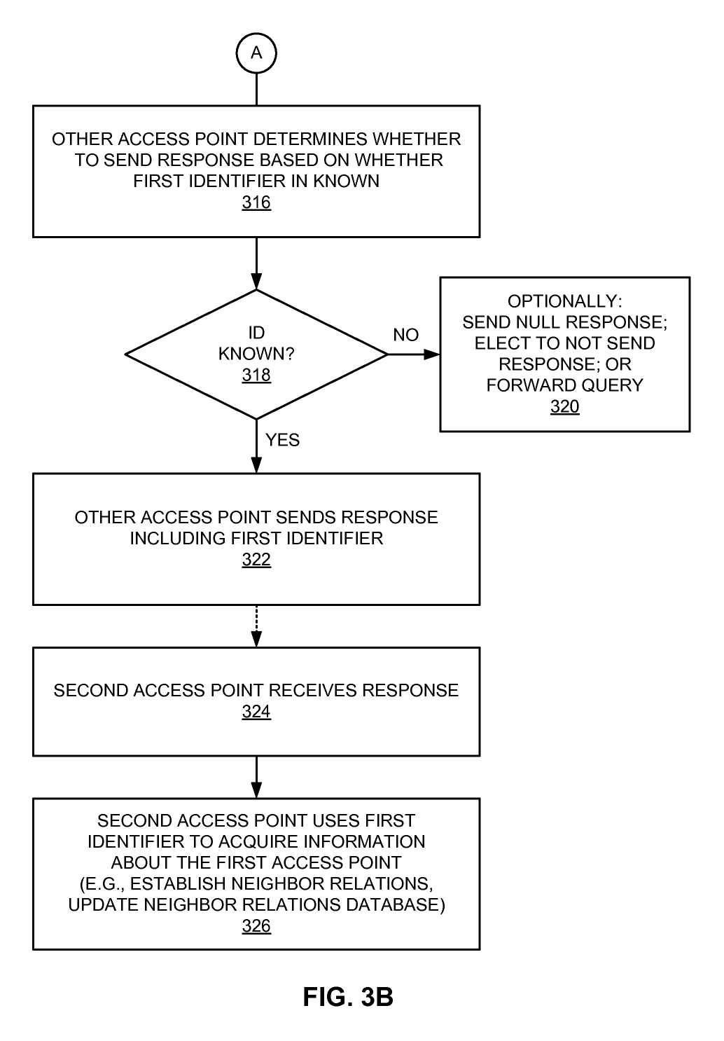

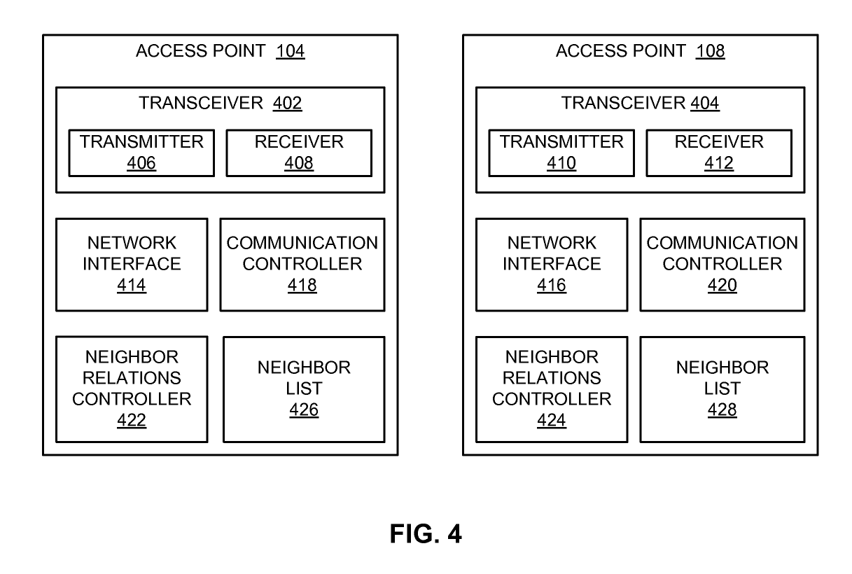

With the above overview in mind, sample operations that may be performed in conjunction with obtaining information about an access point will be described in more detail with reference to the flowchart of FIGS. 3A and 3B. For convenience, the operations of FIGS. 3A and 3B (or any other operations discussed or taught herein) may be described as being performed by specific components (e.g., components of the system 100 or shown in FIG. 4). It should be appreciated, however, that these operations may be performed by other types of components and may be performed using a different number of components. It also should be appreciated that one or more of the operations described herein may not be employed in a given implementation.

FIG. 4 illustrates several sample components that may be incorporated into nodes such as the access point 104 and the access point 108 to perform information acquisition operations as taught herein. The described components also may be incorporated into other nodes in a communication system. For example, a node (e.g., an access point) in a system may include components similar to those described for both the access point 104 and the access point 108 to provide similar functionality. Also, a given node may contain one or more of the described components. For example, an access point may contain multiple transceiver components that enable the access point to operate on multiple frequencies and/or communicate via different technologies.

As shown in FIG. 4, the access point 104 and the access point 108 may include transceivers 402 and 404, respectively, for communicating with wireless nodes. The transceiver 402 includes a transmitter 406 for sending signals (e.g., downlink messages) and a receiver 408 for receiving signals (e.g., uplink messages). The transceiver 404 includes a transmitter 410 for sending signals and a receiver 412 for receiving signals.

Similarly, the access point 104 and the access point 108 may include network interfaces 414 and 426, respectively, for communicating with other network nodes (e.g., sending and receiving queries and responses). For example, each network element may be configured to communicate (e.g., wired or wireless backhaul communication) with a gateway or other suitable entity of a network to facilitate communication with one or more core network nodes (e.g., as represented by node 112 of FIG. 1).

The access point 104 and the access point 108 also include other components that may be used in conjunction with information acquisition operations as taught herein. For example, the access point 104 and the access point 108 may include communication controllers 418 and 420, respectively, for managing communication with other nodes (e.g., sending and receiving messages) and for providing other related functionality as taught herein. In addition, the access point 104 and the access point 108 may include neighbor relations controllers (e.g. neighbor discovery modules) 422 and 424, respectively, for managing neighbor relations (e.g., maintaining neighbor lists 426 and 428, respectively) and for providing other related functionality as taught herein.

Referring to FIGS. 3A and 3B, this example describes a scenario where a second access point acquires a first identifier of a first access point from at least one other access point. Here, the first access point may correspond to the access point 106, the second access point may correspond to the access point 104, and the at least one other access point may correspond to the access point 108.

As represented by block 302 of FIG. 3A, access points in a system may be assigned different identifiers by the network (e.g., when the access points are deployed). Accordingly, the second access point may be assigned first and second identifiers as discussed above.

The first identifier may be used to uniquely identify and/or access the access points. For example, the first identifier may be absolutely unique, unique within a given network (e.g., a cellular operator network), or unique within some other defined area or zone. Examples of this type of identifier include Internet Protocol (IP) addresses, global cell identifiers (GCIs), sector identifiers (sector IDs), or some other type of access point identifier. In some aspects the first identifier comprises a network identification of an access point. This network identification may comprise, for example, an access node identifier (ANID) which may contain an IP address, a mechanism to map the network identification information to the IP address, or a sector ID.

The second identifier may be less unique that the first identifier. For example, the second identifier may be defined with a fewer number of bits than the first identifier. In this way, the second identifier may be used to more efficiently identify the access point. For example, it may be more efficient to encode and transmit such an identifier over the air. However, such an identifier may not be absolutely unique, may be less likely to be unique than a corresponding first identifier, may be unique only within a given portion of a network, may be unique over a smaller area, and so on. Examples of this type of identifier include physical cell identifiers (PCIs) and pilot identifiers (pilot IDs).

As represented by block 304, at some point in time the second access point may acquire the second identifier of the first access point. As discussed above, an access terminal being served by the second access point may send an identification signal including the second identifier of the first access point (e.g., a measurement report comprising a PCI or pilot ID), but not the first identifier. For example, when the second access point (e.g., communication controller 418, FIG. 4) receives a handover request from an access terminal, the handover request may only include a physical layer identifier (e.g., a PCI) of the target access point, and not the IP or network layer identifier. The first identifier may not be provided in such a case due to radio conditions (e.g., the speed at which radio conditions change) at the access terminal or some other factor.

As represented by block 306, the second access point (e.g., neighbor relations controller 422) determines whether the first identifier is known. In some implementations, the access points in the system 100 may conduct neighbor relations over time whereby each access point may acquire and maintain information about its neighbor access points in a neighbor list. Accordingly, the operations of block 306 may involve the second access point checking its neighbor list (e.g., neighbor list 426) to determine whether there is an entry for the first identifier corresponding to the received second identifier (i.e., an entry for the first access point that includes its first identifier).

As represented by blocks 308 and 310, if the first identifier is known, the second access point may continue with its normal operations. For example, if the access terminal served by the second access point is to be handed-over to the first access point, the second access point may communicate with the first access point to commence handover operations.

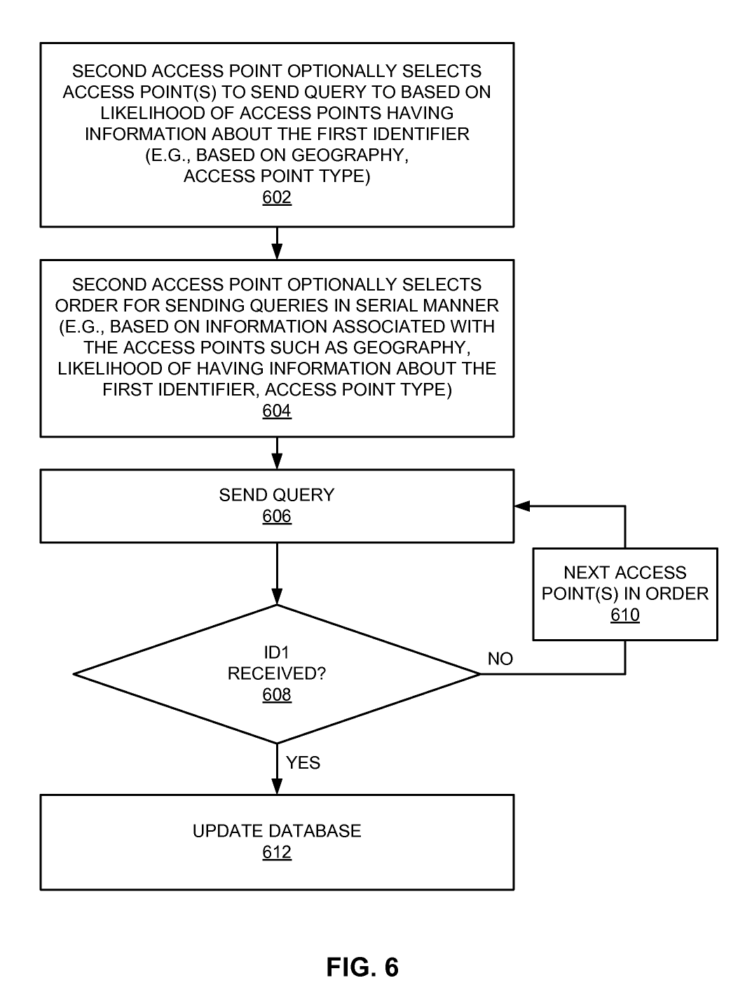

As represented by block 312, if the first identifier is not known, the second access point (e.g., communication controller 418) sends query messages including the second identifier to one or more other access points. As discussed in more detail below in conjunction with FIG. 6, in a case where multiple query messages are sent, these messages may be sent in parallel or in series.

As represented by block 314, the other access point (e.g., communication controller 420) receives a query message. Then, at block 316, the other access point (e.g., neighbor relations controller 424) determines whether to send a response based on whether the first identifier is known. In some implementations this may involve checking a neighbor list (e.g., neighbor list 428) maintained by the other access point in a similar manner as described above at block 306.

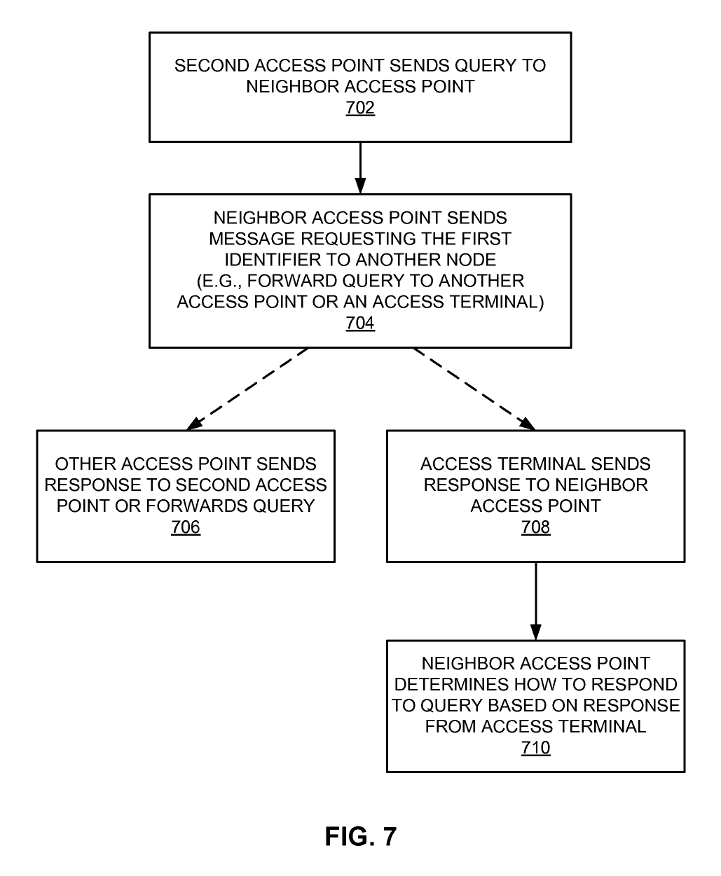

As represented by blocks 318 and 320, if the first identifier is not known, the other access point (e.g., neighbor relations controller 424) may take various courses of action. In some implementations the other access point may send a null response to the second access point to inform the second access point that the first identifier is not known by this other access point. In some implementations the other access point may simply elect to not send any response to the second access point. In this case, the second access point may infer that the first identifier was not known by the other access point when no response is received within a given period of time. In some implementations the other access point may forward the query to another node. This scenario is described in more detail below at FIG. 7.

As represented by block 322, if the other access point knows the first identifier, this access point (e.g., neighbor relations controller 424) sends a response message including the first identifier to the second access point. This message is then received by the second access point (e.g., communication controller 418) at block 324.

Also, in some cases in the event none of the queried access points know the first identifier, the second access point may send a query to one or more access terminals being served by the second access point. For example, the query may be sent to the access terminal that sent the second identifier to the second access point or to some other access terminal(s). In the latter case, one of these other access terminals may be closer to the target access point associated with the second identifier than the reporting access terminal and, hence, may be better able to decode the first identifier being broadcast by the target access point.

As represented by block 326, assuming the first identifier has been received, the second access point (e.g., neighbor relations controller 422) may use the first identifier to acquire information about the first access point. For example, as discussed above, the second access point may establish neighbor relations with the first access point and update the second access point's neighbor relations database (e.g., neighbor list). The second access point may then continue with its normal operations (e.g., commence handover operations, if applicable).

In cases where the second access point sends multiple queries to different access points, the second access point may receive conflicting query responses. For example, since the second identifier may not be unique, different access points (e.g., two or more access points) may report that the second identifier is associated with different first identifiers. In this case, the second access point may take action to resolve the conflict or the second access point may make a determination as to which one of the conflicting first identifiers is most likely to correspond to the second identifier (e.g., that was reported by a served access terminal).

In the former case, the second access point may initiate mediation. For example, the second access point may communicate (e.g., via a gateway/network) with the neighboring access points to issue a request to at least one of access points in conflict to change its respective second identifier. The mediation process may also involve initiating registration of the access point associated with the second identifier (e.g., if this access point has just been added to the system) and communicating updated information to all access points in the neighbor list of the second access point. Furthermore, the updated second identifier information may be communicated to any access terminals being served by the second access point, or alternatively, via continued detection or reception of the second identifier by the access terminal(s).

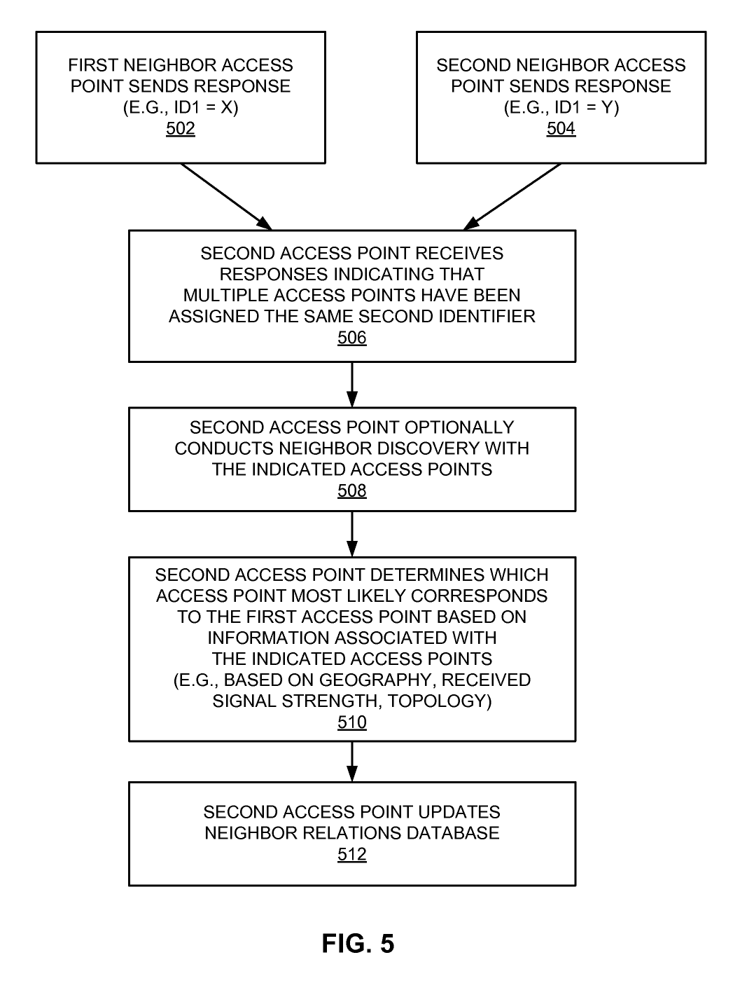

FIG. 5 illustrates sample operations that may be performed in a case where the second access point makes a determination as to which one of the conflicting first identifiers is most likely to correspond to the second identifier. As represented by block 502, a first neighbor access point (e.g., access point 108) may send a response to a query from the second access point (e.g., access point 104), whereby the response indicates that the second identifier corresponds to an access point having a particular value for the first identifier. Conversely, as represented by block 504, a second neighbor access point (e.g., access point 110) may send a response to a query from the second access point, whereby the response indicates that the second identifier corresponds to a different access point having a different value for the first identifier. Accordingly, as represented by block 506, the responses the second access point receives to its queries indicate that multiple access points have been assigned the second identifier specified in the queries.

In some cases the first and second neighbor access points also may include in their respective reports information about the access points (hereafter referred to as the indicated access points) corresponding to the reported first identifiers. This information may include, for example, an indication of the geographic location of an indicated access point, an indication of the topology of the indicated access point (e.g., how the access point is connected to a network or subnet), or some other information that the second access point may use to identify the access point that is most likely to correspond to the second identifier.

Alternatively or in addition, as represented by block 508, the second access point may conduct neighbor discovery with the indicated access points. For example, the second access point may use the first identifier received from the first neighbor access point to establish neighbor relations with one of the indicated access points and use the first identifier received from the second neighbor access point to establish neighbor relations with another indicated access point. In this way, the second access point may acquire information that it may use in an attempt to identify the appropriate access point. For example, the second access point may acquire geographic or topology information as described above. Also, the second access point may determine the received signal strength of signals received from each of the indicated access points.

As represented by block 510, the second access point (e.g., neighbor relations controller 422) determines which of the access point indicated by the first identifiers received at block 506 is most likely to correspond to the second identifier. In some aspects, this determination may be based on information associated with the access points as discussed above. For example, in cases where the determination is based on the relative geographic proximity of the access points to the second access point, the second access point may select the indicated access point that is closest to the second access point. In cases where the determination is based on the topology of the indicated access points, the second access point may select the indicated access point that has a topology that is most similar to the topology of the second access point (e.g., an access point that is on the same subnet or a relatively “close” subnet). In cases where the determination is based on the received signal strength associated with the indicated access points, the second access point may select the indicated access point that results in the strongest received signal strength.

As represented by block 512, the second access point (e.g., neighbor relations controller 422) may then update its neighbor relations database (e.g., neighbor list 426) to specify that the second identifier corresponds to the first identifier of the access point selected at block 510.

Referring now to block 602 of FIG. 6, in some cases the second access point may identify the access point or access points to which a query is to be sent from a set of access points (e.g., a set of neighbor access points in a neighbor list). In some aspects this identification may be based on the relative likelihood that the respective neighbor access points have information about the first identifier corresponding to the second identifier. For example, it may be determined that neighbor access points that are closer to the second access point may be more likely to have information about the first identifier. Also, it may be determined that certain types of neighbor access points may be more likely to have information about the first identifier. As an example, the neighbor relations database at a macro access point may be deemed be more reliable and/or more extensive that the neighbor relations database at a smaller coverage access point (e.g., a femto cell). Consequently, to reduce the number of query message that may prove futile, the second access point may elect to only query those access points that are relatively close (e.g., within a threshold distance or having a received signal strength above a threshold) and/or that are of a certain type. It should be appreciated that the operations of block 602 may be implemented in conjunction with the operations discussed above (e.g., at block 312).

Referring now to block 604 of FIG. 6, as mentioned above, the second access point may send multiple queries in a parallel or serial manner. In cases where the queries are sent in a serial manner, the second access point (e.g., the neighbor relations controller 422) may select the order in which the queries are sent so that queries are first sent to those access points that are most likely to have information about the first identifier. In some implementations this ordering may be based on information associated with the neighbor access points. For example, the ordering may be based on the relative proximity of the neighbor access points to the second access point. Also, the ordering may be based on the access point type (e.g., macro access points are to the queried first).

As represented by block 606, once the ordering is determined, a query is sent to the access point that is first in the order (or the subset of access points that are first in the order). As represented by blocks 608 and 610, in the event an affirmative response is not received to this query or these queries (e.g., within a defined period of time), a query is sent the next access point (or access points) specified by the order. As represented by block 612, if an affirmative response is received at any time during the process, the second access point may cease sending queries and update its database with the acquired first identifier (e.g., as described above at block 512).

Referring now to FIG. 7, in some cases an access point may elect to forward a query to another node. As discussed above, the second access point starts this process by sending a query to a neighbor access point (block 702).

As represented by block 704, if the neighbor access point does not have the first identifier, the neighbor access point may send a message requesting the first identifier to another node. In some cases the other node may comprise another access point (e.g., an access point from the neighbor list maintained by the neighbor access point) while in other cases the other node may comprise an access terminal (e.g., an access terminal being served by the neighbor access point).

As represented by block 706, the other access point may send an appropriate response to the second access point (e.g., optionally via the neighbor access point) depending on whether the other access point knows the first identifier. In some cases, if the other access point does not know the first identifier, the other access point also may forward the query (e.g., to an access point in its neighbor list).

As represented by block 708, the access terminal may monitor a downlink channel (or some other channel) for messages that include the first identifier. For example, the access terminal may be able to receive broadcast messages that include the first identifier from the access point associated with the second identifier. The access terminal may then send a response indicative of whether the first identifier has been received to its serving access point (e.g., the neighbor access point). The neighbor access point may then determine how to respond to the query based on the response from the access terminal. For example, the neighbor access point may forward an affirmative response (including the first identifier) to the second access point. In the event an affirmative response is not received, the neighbor access point may elect to forward the query to yet another node.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. Although certain aspects of the disclosure may be described using 3GPP terminology, it is to be understood that the teachings herein may be applied to 3GPP (Re199, Re15, Re16, Re17) technology, as well as 3GPP2 (1×RTT, 1×EV-DO Re1O, RevA, RevB) technology and other technologies.

In some aspects the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

A node (e.g., an access point) that provides coverage over a relatively large area may be referred to as a macro node while a node that provides coverage over a relatively small area (e.g., a residence) may be referred to as a femto node. It should be appreciated that the teachings herein may be applicable to nodes associated with other types of coverage areas. For example, a pico node may provide coverage (e.g., coverage within a commercial building) over an area that is smaller than a macro area and larger than a femto area. In various applications, other terminology may be used to reference a macro node, a femto node, or other access point-type nodes. For example, a macro node may be configured or referred to as an access node, base station, access point, eNodeB, macro cell, and so on. Also, a femto node may be configured or referred to as a Home NodeB, Home eNodeB, access point base station, femto cell, and so on. In some implementations, a node may be associated with (e.g., divided into) one or more cells or sectors. A cell or sector associated with a macro node, a femto node, or a pico node may be referred to as a macro cell, a femto cell, or a pico cell, respectively.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

An access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

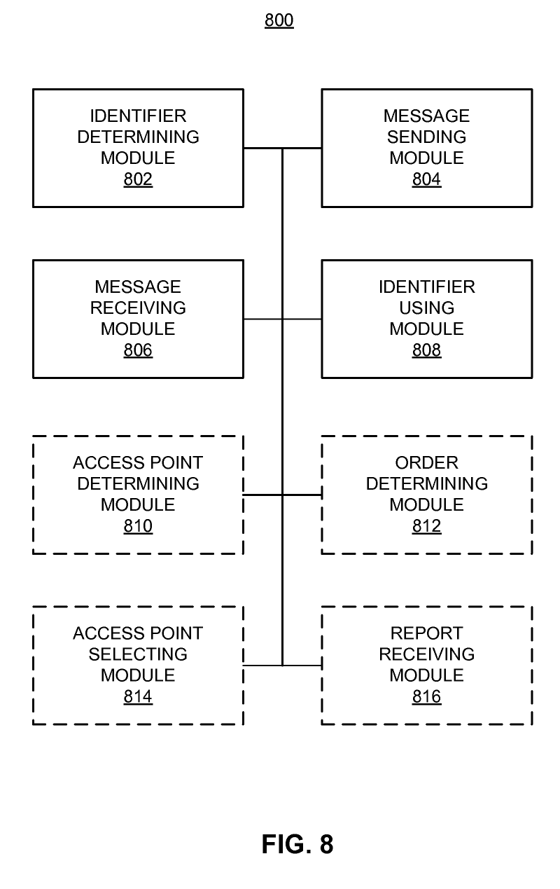

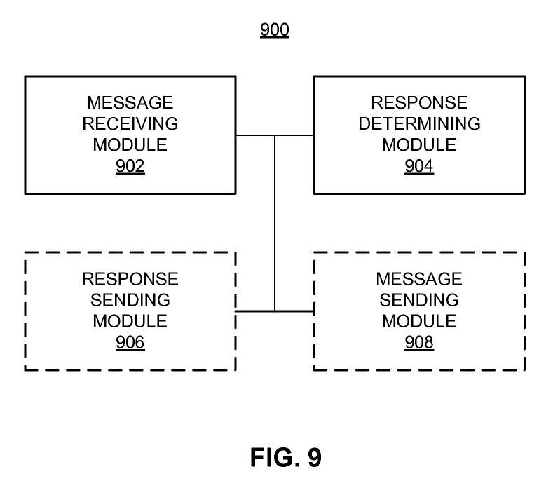

The functionality described herein (e.g., with regard to one or more of the accompanying figures) may correspond in some aspects to similarly designated “means for” functionality in the appended claims. Referring to FIGS. 8 and 9, apparatuses 800 and 900 are represented as a series of interrelated functional modules. Here, an identifier determining module 802 may correspond at least in some aspects to, for example, a neighbor relations controller as discussed herein. A message sending module 804 may correspond at least in some aspects to, for example, a communication controller as discussed herein. A message receiving module 806 may correspond at least in some aspects to, for example, a communication controller as discussed herein. An identifier using module 808 may correspond at least in some aspects to, for example, a neighbor relations controller as discussed herein. An access point determining module 810 may correspond at least in some aspects to, for example, a neighbor relations controller as discussed herein. An order determining module 812 may correspond at least in some aspects to, for example, a neighbor relations controller as discussed herein. An access point selecting module 814 may correspond at least in some aspects to, for example, a neighbor relations controller as discussed herein. A report receiving module 816 may correspond at least in some aspects to, for example, a communication controller as discussed herein. A message receiving module 902 may correspond at least in some aspects to, for example, a communication controller as discussed herein. A response determining module 904 may correspond at least in some aspects to, for example, a neighbor relations controller as discussed herein. A response sending module 906 may correspond at least in some aspects to, for example, a neighbor relations controller as discussed herein. A message sending module 908 may correspond at least in some aspects to, for example, a neighbor relations controller as discussed herein.

The functionality of the modules of FIGS. 8 and 9 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. The functionality of these modules also may be implemented in some other manner as taught herein. In some aspects one or more of any dashed blocks in FIGS. 8 and 9 are optional.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (IC), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. It should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of maintaining information about a first access point that has been assigned a first identifier and a second identifier, comprising:
determining whether the first identifier is known at a second access point;
sending at least one message to at least one other access point to determine the first identifier if the first identifier is not known at the second access point, wherein the at least one message includes the second identifier;
receiving at least one other message in response to the sending of the at least one message, wherein the at least one other message specifies the first identifier; and
using the specified first identifier to acquire information about the first access point.

2. The method of claim 1, wherein the use of the specified first identifier comprises establishing neighbor relations with the first access point.

3. The method of claim 1, wherein the use of the specified first identifier comprises updating a neighbor relations database maintained at the second access point.

4. The method of claim 1, wherein the at least one other message comprises a plurality of responses that indicate that a plurality of access points have been assigned the second identifier, the method further comprising:
determining which of the plurality of access points most likely corresponds to the first access point based on information associated with the plurality of access points.

5. The method of claim 4, wherein the information comprises relative geographic proximities of the plurality of access points to the second access point.

6. The method of claim 4, wherein the information comprises received signal strengths of signals from the plurality of access points.

7. The method of claim 4, wherein the information comprises topology information associated with the plurality of access points.

8. The method of claim 4, wherein the information is received via the responses from the at least one access point or via neighbor relations messages from the plurality of access points.

9. The method of claim 1, wherein:
the at least one message comprises a plurality of messages;
the at least one other access point comprises a plurality of access points;
the plurality of messages are sent in a serial manner; and
the method further comprises determining an order for sending the plurality of messages to the plurality of access points based on information associated with the access points.

10. The method of claim 9, wherein the information comprises relative geographic proximities of the plurality of access points to the second access point.

11. The method of claim 9, wherein the information indicates which of the plurality of access points is more likely to have information about the first identifier.

12. The method of claim 9, further comprising selecting the plurality of access points from a set of neighboring access points by determining which of the neighboring access points are more likely to have information about the first identifier.

13. The method of claim 1, further comprising receiving a report that includes the second identifier from an access terminal, wherein the determination is triggered based on the receipt of the report.

14. The method of claim 1, wherein the at least one other access point comprises at least one neighbor access point of the second access point.

15. The method of claim 1, wherein:
the first identifier comprises an Internet Protocol address, a sector identifier, or a global cell identifier; and
the second identifier comprises a physical cell identifier or a pilot identifier.

16. The method of claim 1, wherein the first identifier provides a more unique identification of the first access point than the second identifier.

17. An apparatus for maintaining information about a first access point that has been assigned a first identifier and a second identifier, comprising:
a neighbor relations controller configured to determine whether the first identifier is known at a second access point; and
a communication controller configured to send at least one message to at least one other access point to determine the first identifier if the first identifier is not known at the second access point, wherein the at least one message includes the second identifier, and wherein the communication controller further configured to receive at least one other message in response to the sending of the at least one message, and wherein the at least one other message specifies the first identifier;
wherein the neighbor relations controller is further configured to use the specified first identifier to acquire information about the first access point.

18. The apparatus of claim 17, wherein the use of the specified first identifier comprises establishing neighbor relations with the first access point.

19. The apparatus of claim 17, wherein the use of the specified first identifier comprises updating a neighbor relations database maintained at the second access point.

20. The apparatus of claim 17, wherein:
the at least one other message comprises a plurality of responses that indicate that a plurality of access points have been assigned the second identifier; and
the neighbor relations controller is further configured to determine which of the plurality of access points most likely corresponds to the first access point based on information associated with the plurality of access points.

21. The apparatus of claim 20, wherein the information comprises at least one of the group consisting of: relative geographic proximities of the plurality of access points to the second access point, received signal strengths of signals from the plurality of access points, and topology information associated with the plurality of access points.

22. The apparatus of claim 17, wherein:
the at least one message comprises a plurality of messages;
the at least one other access point comprises a plurality of access points;
the plurality of messages are sent in a serial manner; and
the neighbor relations controller is further configured to determine an order for sending the plurality of messages to the plurality of access points based on information associated with the access points.

23. The apparatus of claim 22, wherein the information indicates which of the plurality of access points is more likely to have information about the first identifier.

24. An apparatus for maintaining information about a first access point that has been assigned a first identifier and a second identifier, comprising:
means for determining whether the first identifier is known at a second access point;
means for sending at least one message to at least one other access point to determine the first identifier if the first identifier is not known at the second access point, wherein the at least one message includes the second identifier;
means for receiving at least one other message in response to the sending of the at least one message, wherein the at least one other message specifies the first identifier; and
means for using the specified first identifier to acquire information about the first access point.

25. The apparatus of claim 24, wherein the use of the specified first identifier comprises establishing neighbor relations with the first access point.

26. The apparatus of claim 24, wherein the use of the specified first identifier comprises updating a neighbor relations database maintained at the second access point.

27. The apparatus of claim 24, wherein:
the at least one other message comprises a plurality of responses that indicate that a plurality of access points have been assigned the second identifier; and
the apparatus further comprises means for determining which of the plurality of access points most likely corresponds to the first access point based on information associated with the plurality of access points.

28. The apparatus of claim 27, wherein the information comprises at least one of the group consisting of: relative geographic proximities of the plurality of access points to the second access point, received signal strengths of signals from the plurality of access points, and topology information associated with the plurality of access points.

29. The apparatus of claim 24, wherein:
the at least one message comprises a plurality of messages;
the at least one other access point comprises a plurality of access points;
the plurality of messages are sent in a serial manner; and
the apparatus further comprises means for determining an order for sending the plurality of messages to the plurality of access points based on information associated with the access points.

30. The apparatus of claim 29, wherein the information indicates which of the plurality of access points is more likely to have information about the first identifier.

31. A computer-program product, comprising:
computer-readable medium comprising code for causing a computer to:
determine whether the first identifier is known at a second access point;
send at least one message to at least one other access point to determine the first identifier if the first identifier is not known at the second access point, wherein the at least one message includes the second identifier;
receive at least one other message in response to the sending of the at least one message, wherein the at least one other message specifies the first identifier; and
use the specified first identifier to acquire information about the first access point.

32. The computer-program product of claim 31, wherein the use of the specified first identifier comprises establishing neighbor relations with the first access point.

33. The computer-program product of claim 31, wherein the use of the specified first identifier comprises updating a neighbor relations database maintained at the second access point.

34. The computer-program product of claim 31, wherein:
the at least one other message comprises a plurality of responses that indicate that a plurality of access points have been assigned the second identifier; and
the computer-readable medium further comprises code for causing the computer to determine which of the plurality of access points most likely corresponds to the first access point based on information associated with the plurality of access points.

35. The computer-program product of claim 34, wherein the information comprises at least one of the group consisting of: relative geographic proximities of the plurality of access points to the second access point, received signal strengths of signals from the plurality of access points, and topology information associated with the plurality of access points.

36. The computer-program product of claim 31, wherein:
the at least one message comprises a plurality of messages;
the at least one other access point comprises a plurality of access points;
the plurality of messages are sent in a serial manner; and
the computer-readable medium further comprises code for causing the computer to determine an order for sending the plurality of messages to the plurality of access points based on information associated with the access points.

37. The computer-program product of claim 36, wherein the information indicates which of the plurality of access points is more likely to have information about the first identifier.

38. A method of providing information about a first access point that has been assigned a first identifier and a second identifier, comprising:
receiving a message from a second access point at a third access point, wherein the message requests the first identifier and includes the second identifier; and
determining whether to send a response to the message based on whether the first identifier is known at the third access point.

39. The method of claim 38, further comprising sending the response if the first identifier is known at the third access point, wherein the response includes the first identifier.

40. The method of claim 39, wherein the response further indicates a geographical location of the first access point and/or a topology of the first access point.

41. The method of claim 38, further comprising, if the first identifier is not known at the third access point, sending a null response or electing to not send the response.

42. The method of claim 38, further comprising sending another message requesting the first identifier to at least one node if the first identifier is not known at the third access point.

43. The method of claim 42, wherein the at least one node comprises at least one other access point or at least one access terminal.

44. The method of claim 38, wherein:
the first identifier comprises an Internet Protocol address, a sector identifier, or a global cell identifier; and
the second identifier comprises a physical cell identifier or a pilot identifier.

45. The method of claim 3 8, wherein the first identifier provides a more unique identification of the first access point than the second identifier.

46. An apparatus for providing information about a first access point that has been assigned a first identifier and a second identifier, comprising:
a communication controller configured to receive a message from a second access point at a third access point, wherein the message requests the first identifier and includes the second identifier; and
a neighbor relations controller configured to determine whether to send a response to the message based on whether the first identifier is known at the third access point.

47. The apparatus of claim 46, wherein:
the neighbor relations controller is further configured to send the response if the first identifier is known at the third access point; and
the response includes the first identifier.

48. The apparatus of claim 47, wherein the response further indicates a geographical location of the first access point and/or a topology of the first access point.

49. The apparatus of claim 46, wherein the neighbor relations controller is further configured to send another message requesting the first identifier to at least one node if the first identifier is not known at the third access point.

50. An apparatus for providing information about a first access point that has been assigned a first identifier and a second identifier, comprising:
means for receiving a message from a second access point at a third access point, wherein the message requests the first identifier and includes the second identifier; and
means for determining whether to send a response to the message based on whether the first identifier is known at the third access point.

51. The apparatus of claim 50, further comprising means for sending the response if the first identifier is known at the third access point, wherein the response includes the first identifier.

52. The apparatus of claim 51, wherein the response further indicates a geographical location of the first access point and/or a topology of the first access point.

53. The apparatus of claim 50, further comprising means for sending another message requesting the first identifier to at least one node if the first identifier is not known at the third access point.

54. A computer-program product, comprising:
computer-readable medium comprising code for causing a computer to:
receive a message from a second access point at a third access point, wherein the message requests the first identifier and includes the second identifier; and
determine whether to send a response to the message based on whether the first identifier is known at the third access point.

55. The computer-program product of claim 54, wherein:
the computer-readable medium further comprises code for causing the computer to send the response if the first identifier is known at the third access point; and
the response includes the first identifier.

56. The computer-program product of claim 55, wherein the response further indicates a geographical location of the first access point and/or a topology of the first access point.

57. The computer-program product of claim 54, wherein the computer-readable medium further comprises code for causing the computer to send another message requesting the first identifier to at least one node if the first identifier is not known at the third access point.
